(19) United States
(12) Patent Application Publication
(10) Pub. No.: US 2026/0330903 A1
(43) Pub. Date: Oct. 22, 2026

(54) A SYSTEM AND METHOD FOR SHARING ACCESS TO AN ELECTRONIC LOCK

(71) Applicant: IGLOOCOMPANY PTE. LTD., Singapore (SG)

(72) Inventors: KHEE KIEN HO, Singapore (SG); Sastra WINARTA, Singapore (SG); Johannes DWIARTANTO, Singapore (SG); Walter TAY ANN LEE, Singapore (SG); Soon Kiat SEE, Singapore (SG); Anthony CHOW WEN JIE, Singapore (SG)

(21) Appl. No.: 19/105,836

(22) PCT Filed: Aug. 24, 2023
(86) PCT No.: PCT/SG2023/050583

§ 371 Date: Feb. 24, 2025

(30) Foreign Application Priority Data
Aug. 25, 2022 (SG) 10202250817T

(51) Int. Cl. G07C 9/00

(52) U.S. Cl. CPC G07C 9/00571; G07C 9/00309; G07C 9/00857; G07C 2009/00865; G07C 2209/02

(57) ABSTRACT

The present invention discloses a computer-implemented method for sharing access to an electronic lock comprising: generating, by the access management system, an access unique resource locator (URL) associated with an instant application for provisioning access to the electronic lock to a grantee, wherein the access URL includes an access token, sending the access URL to a mobile device of the grantee. The method further includes receiving, by the access management system, an access request from the mobile device to activate the access URL, wherein the access request includes a first access token, verifying the access request by matching the first access token with the access token generated for the access URL, transmitting an access credential to the mobile device to cause the instant application to be rendered on the mobile device upon a positive verification of the access request, and transmitting the access credential to the electronic lock so as to cause the electronic lock to be unlocked in response to receipt of an unlock request on the instant application.

### TECHNICAL FIELD

The present disclosure generally relates to electronic lock systems. More particularly, the present disclosure relates to a system and a method for sharing access to an electronic lock.

### BACKGROUND

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

There are many types of electronic lock systems including electronic locks that such as electromagnetic locks, deadbolts, latches, rim, locks and mortise locks. There are solutions in the prior art that utilize an executable program such as a mobile application utilizing wireless technologies to unlock a lock. For such electronic lock systems, granting access to a guest to an electronic lock system and sharing that access are common in the prior art. For example, prior solutions disclose that this will require the grantee to search the mobile application store of a user device, download and install the executable program on the user device, register a user account, after which the grantor can grant the keyless access to the grantee, and finally, the grantee will be able to receive the rights to unlock the locking system.

Another prior solution discloses that access can be shared in the form of a web address, after which the grantee will have to search the mobile application store of a user device, download and install the executable program on the user device, register an account, click on the web address, and then receive the rights to unlock the locking system.

The aforesaid solutions do so in a way that are complex and cumbersome to the guest. With the proliferation of apps in the mobile application store, users are less inclined to download a mobile application or executable program for a one time use.

Another solution involves a grantee receiving a matrix code (barcode or QR code), or a picture encoded with bits of the relevant information in the access credential. The grantee presents the code or picture to a camera present in the locking system. The camera reads the information from the picture, and the locking system checks with a server to see if the information in the access credential is valid, and finally the locking system will unlock if the access credential is valid. This solution is restrictive as it requires the locking system to be connected to a network.

For electronic door lock systems that are utilized in offices or buildings managed by a property management company or a hospitality management operator, third party system integrators who wish to enable a sharing access feature on multiple electronic locks with wireless transceivers within the offices or buildings would have to spend significant time and effort to integrate lock control software into their applications in order to perform privileged actions to the electronic locks.

The present invention attempts to address or to overcome at least some of the aforementioned problems. Accordingly, it would be desirable to provide a method and a system for sharing access to an electronic lock. Accordingly, it would be desirable to improve the efficiency and flexibility of building, residential and hospitality management operators managing multiple entry points secured by electronic locks. Accordingly, it would be desirable to provide reassurance and increased security to individual owners of highly secured areas, residential or commercial units that their properties can only be accessed by authorized users.

### SUMMARY OF THE INVENTION

In accordance with a first aspect of the invention, there is disclosed a computer-implemented method for sharing access to an electronic lock comprising: generating, by the access management system, an access unique resource locator (URL) associated with an instant application for provisioning access to the electronic lock to a grantee, wherein the access URL includes an access token, sending the access URL to a mobile device of the grantee. The method further includes receiving, by the access management system, an access request from the mobile device to activate the access URL, wherein the access request includes a first access token, verifying the access request by matching the first access token with the access token generated for the access URL, transmitting an access credential to the mobile device to cause the instant application to be rendered on the mobile device upon a positive verification of the access request, and transmitting the access credential to the electronic lock so as to cause the electronic lock to be unlocked in response to receipt of an unlock request on the instant application.

According to various embodiments, the access URL includes a shortened uniform resource locator hyperlink.

According to various embodiments, the access URL includes a matrix barcode.

According to various embodiments, the access token is associated with an access identity of the grantee.

According to various embodiments, the access identity includes one or more user identifiers associated with the grantee.

According to various embodiments, the access token is associated with an access right granted to the grantee.

According to various embodiments, the access credential is transmitted to a bridge before the access credential is transmitted to the electronic lock.

According to various embodiments, the instant application includes instant application includes one or more configurable elements configured based on an identity of the grantee and an identity of the grantor.

According to various embodiments, the method further include the steps of: in response to the positive verification of the access request, generating, by the access management system, a first factor authentication request to be transmitted to the mobile device; receiving, by the access management system, an input first factor authentication data from the mobile device; determining, if the input first factor authentication data corresponds with the first factor authentication data associated with the grantee.

According to various embodiments, the method further includes the steps of: generating, by the access management system, a second factor authentication request for transmission to the mobile device in response to the input first factor authentication data matching the first factor authentication data associated with the grantee; receiving, by the access management system, an input second factor authentication data from the mobile device; and determining if the input second factor authentication data corresponds with the second factor authentication data associated with the grantee.

In accordance with a second aspect of the invention, there is disclosed a system for sharing access to an electronic lock, the system comprising at least one processor, and at least one memory including computer program code; the at least one memory and the computer program code configured to, with the at least one processor, cause the system at least to: generate, by the access management system, an access unique resource locator (URL) associated with an instant application for provisioning access to the electronic lock to a grantee, wherein the access URL includes an access token; send the access URL to a mobile device of the grantee; receive, by the access management system, an access request from the mobile device to activate the access URL, wherein the access request includes a first access token; verify the access request by matching the first access token with the access token generated for the access URL; transmit an access credential to the mobile device to cause the instant application to be rendered on the mobile device upon a positive verification of the access request, and transmit the access credential to the electronic lock so as to cause the electronic lock to be unlocked in response to receipt of an unlock request on the instant application.

According to various embodiments, the access URL includes a shortened uniform resource locator hyperlink.

According to various embodiments, the access URL includes a matrix barcode.

According to various embodiments, the access token is associated with an access identity of the grantee.

According to various embodiments, the access identity includes one or more user identifiers associated with the grantee.

According to various embodiments, the access token is associated with an access right granted to the grantee.

According to various embodiments, the access credential is transmitted to a bridge before the access credential is transmitted to the electronic lock.

According to various embodiments, the instant application includes one or more configurable elements configured based on an identity of the grantee and an identity of the grantor.

According to various embodiments, it further includes the steps of: in response to the positive verification of the access request, generate, by the access management system, a first factor authentication request to be transmitted to the mobile device; receive, by the access management system, an input first factor authentication data from the mobile device; determine, if the input first factor authentication data corresponds with the first factor authentication data associated with the grantee.

According to various embodiments, it further includes the steps of: generate, by the access management system, a second factor authentication request for transmission to the mobile device in response to the input first factor authentication data matching the first factor authentication data associated with the grantee; receive, by the access management system, an input second factor authentication data from the mobile device; and determine if the input second factor authentication data corresponds with the second factor authentication data associated with the grantee.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1 shows a high-level overview diagram of a system for sharing access to an electronic lock according to an embodiment of the invention;

FIG. 2 shows a high-level overview diagram of a system for sharing access to an electronic lock according to another embodiment of the invention;

FIG. 3 illustrates a flow diagram of a method for sharing access to the electronic lock according to various embodiments;

FIG. 4 illustrates a flow diagram of a method for sharing access to the electronic lock according to another embodiment;

FIG. 5 shows a flow diagram of a method for sharing access to the electronic lock according to various embodiments;

FIG. 6 illustrates a graphical user interface of an instant application on a mobile device according to various embodiments;

FIG. 7 shows a detailed flow diagram of a grantor sharing access to the electronic lock with a grantee according to various embodiments;

FIG. 8 shows a detailed flow diagram of a grantor sharing access to the electronic lock with a grantee according to another embodiment; and

FIG. 9 illustrates a block diagram of an electronic lock according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

In order that the invention may be readily understood and put into practical effect, particular embodiments will now be described by way of examples and not limitations, and with reference to the figures. It will be understood that any property described herein for a specific system may also hold for any system described herein. It will be understood that any property described herein for a specific method may also hold for any method described herein. Furthermore, it will be understood that for any system or method described herein, not necessarily all the components or steps described must be enclosed in the system or method, but only some (but not all) components or steps may be enclosed.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,”“an,” and “the” include plural references. The meaning of “in” includes “in” and “on.”

As used herein, the term “receiving” requests, responses, communications and any types of multimedia contents from a device or component includes receiving the requests, responses, communications, and any types of multimedia contents indirectly, such as when forwarded by one or more other devices or components. Similarly, “sending” a request, responses, communications, and any types of multimedia contents to a device or component includes sending the request, responses, communications, and any types of multimedia contents indirectly, such as when forwarded by one or more other devices or components.

To achieve the stated features, advantages and objects, the present disclosure provides a method and a system for sharing access to an electronic lock. The invention proposes to improve the security and efficiency of sharing access to an electronic lock. The present disclosure can be applied to electronic locks with wireless communication capabilities such as bluetooth or wifi or multi-factor authentication capabilities. The present invention discloses a method and system for sharing access to a grantee to perform actions on a locking system. The present invention proposes to improve the user experience and shareability of the access of the electronic lock. The present invention proposes to allow third party system integrators to integrate the sharing access feature using software application programming interfaces.

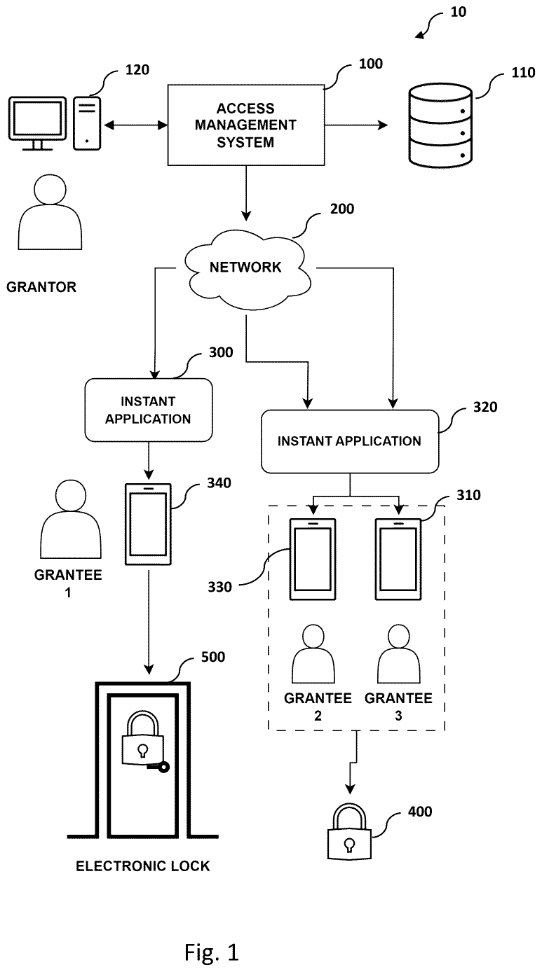

FIG. 1 shows a high-level overview diagram of a system for sharing access to an electronic lock according to an embodiment of the invention. The system 10 includes an access management system 100 connected to a database 110 which is accessible by a computing device 120. A user with a mobile device 340 who wishes to unlock an electronic lock 500 located at an access point may do so through an access unique resource locator (URL) sent to the mobile device 340 by the access management system through a computing device 120. The user activates the access URL which promptly launches but does not download an instant application 320 on the user device 340 and transmits an access token associated with the mobile device 340 to the access management system 100 for authentication. Upon authentication, the access management system 100 sends an access credential to the mobile device and the user proceeds to perform a privileged action which includes sending the access credential and the privileged action to the electronic lock for unlocking the electronic lock. In the same context, the access URL can be sent to more than one mobile devices 310, 330 for the purpose of unlocking an electronic lock 400.

The access management system 100 is used in real estate management operators such as commercial buildings, hotels, co-living spaces, serviced apartments or suites, short-term accommodation units, groups of apartment units managed by a single operator, fleet management for management of vehicles transporting high-value cargo or for management of vehicles, and infrastructure management of critical key installations for essential services or critical data. The access management system 100 may be integrated with existing hotel or accommodation reservation systems, fleet management systems or infrastructure management systems. Other means of automated import or manual entry of authorized users may be provisioned to facilitate integration with the access management system. The access management system 100 offers management operators an efficient and secure way of managing multiple entry points that are each secured by an electronic lock. The access management system 100 controls and manages the authorized users who may have access to one or more of these entry points with a specific duration of access.

The access management system 100 may include several modules including a user management module, a role management module, a lock management module, a grant access module and a dashboard module. The system 100 may include an application server (not shown) in communication with a computing device 120 over a network 200. Although the singular is used to describe the application server, an application server as described herein may operate as a single computing device, a set of computing devices, or a distributed computing cluster. Similarly, a computing device 120 may be one or more programming devices capable of running a web application or native application to communicate with the application server. The application server and/or computing device may have one or more processors configured to execute instructions retained in the database or memory. In some embodiments, application server and/or computing device may include servers, computers, laptops, notebooks, portable handheld computers, mobile communication devices, smart phones, personal digital assistants, tablets, wearable devices, Internet of Things (IoT) devices, or any other communication devices capable of sending and receiving data over the network 200.

As used herein, the term ‘network’ refers to a Local Area Network (LAN), a Metropolitan Area Network (MAN), a Wide Area Network (WAN), a Low Power Wide Area Network (LPWAN), a cellular network, a proprietary network, and/or Internet Protocol (IP) network such as the Internet, an Intranet or an extranet. Each device, module or component within the system may be connected over a network or may be directly connected. A person skilled in the art will recognize that the terms ‘network’, ‘computer network’ and ‘online’ may be used interchangeably and do not imply a particular network embodiment. In general, any type of network may be used to implement the online or computer networked embodiment of the present invention. The network may be maintained by a server or a combination of servers or the network may be serverless. Additionally, any type of protocol (for example, HTTP, FTP, ICMP, UDP, WAP, SIP, H.323, NDMP, TCP/IP) may be used to communicate across the network. The devices as described herein may communicate via one or more such communication networks. The communication over the network may utilize data encryption. Encryption may be performed by way of any of the techniques available now available in the art or which may become available.

The access management system 100 includes various modules that are accessible by administrators and authorized users via a mobile application or web application for configuration, provisioning and deprovisioning of multiple authorized users for multiple entry points each secured by an electronic lock. A mobile or a web application can be a mobile or a web application that runs and be executed on, for example, a user device or a mobile communication device or a computing device.

In the prior art solutions, a mobile application can be accessed via the user device of the grantor, administrator or grantees. The mobile application allows the user device to control the electronic lock via wireless communication protocols or short range wireless communication protocols such as Bluetooth or Bluetooth Low Energy by pairing the user device with the electronic lock. When this is done, the user can edit or delete passcodes, create customised unique passcodes, or synchronize the data within the user device to the electronic lock.

Additionally in the prior art solutions, when a grantor of the electronic lock wishes to provide access to a grantee, access can be shared in the form of a web address, after which the grantee will have to search the mobile application store of a user device, download and install the executable program on the user device, register an account, click on the web address, and then receive the rights to unlock the locking system. Another solution requires the grantee to search the mobile application store of a user device, download and install the executable program on the user device, register a user account, after which the grantor can grant the keyless access to the grantee, and finally, the grantee will be able to receive the rights to unlock the locking system. These solutions are however complex and cumbersome to the grantee. With the proliferation of apps in the mobile application store, grantees are less inclined to download a mobile application or executable program for a one time use.

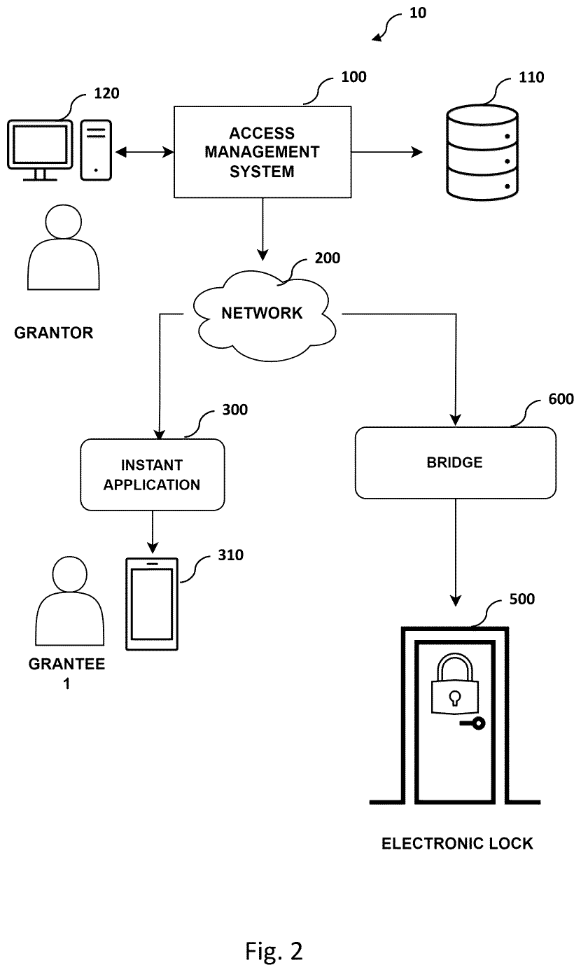

To address the above problems in the prior solutions, an embodiment of the invention as illustrated in FIGS. 1 and 2 proposes that a grantor can create an access unique resource locator (URL) on an access management system 100 via a computing device 120. The grantor can share or distribute to the grantee with a mobile device 340 via one or more means, such as text messaging, email, or other distribution methods. In a non-limiting example, the unique resource locator is associated to an instant application that is associated with a grantee and access rights associated with the grantee for the purpose of unlocking an electronic lock. The unique resource locator may be stored by the access management system or on the database connected to the access management system. The unique resource locator enables access to the instant application stored on the access management system 100. In other embodiments, the access URL is in the form of a short uniform resource locator hyperlink embedded in the access request, a matrix barcode for example barcode or a QR code, or encoded into an image for easy distribution. The access URL contains, but not limited to, an access token that is associated with the access identity of the grantee and/or access rights the grantor has granted to the grantee. Typically, the access URL is protected from unauthorized access via a cryptographic access token, rate limiting and other techniques commonly used in the art.

When the grantee receives the the access URL on the mobile device 340, the grantee can activate the access URL via an access request where upon activation, an instant application 300 is launched on the mobile device 340. An instant application is an application that can be downloaded and run without the user having to install it on the mobile device, for example, Google Play Instant applications on Android devices or App Clips on iOS devices. On activation of the instant application 300, the access request is sent to the access management system 100 together with the mobile device identifier of the grantee and access token associated with the access rights of the grantee. On authentication of the access token and the mobile device identifier, an access credential is sent to the mobile device 340 and the instant application is rendered on the mobile device 340 as a graphical user interface (GUI) feature based on the access token associated with the access rights provided to the grantee. The access URL enables the grantee to retrieve the instant application from the access management system, and information about the access rights and its associated information including the text information, images and user interface elements based on the data taken from the access token. The information is then used to render the user interface of the instant application.

When the grantee performs a privileged action on the instant application such as an unlock action for unlocking the associated electronic lock 500, the instant application 300 in turn sends the access credential to the electronic lock 500 to perform the unlock action. Communications between the instant application 300 on the mobile device 340 and the electronic lock 500 can be based on one or more wireless connections, such as Bluetooth and/or Bluetooth LE connections, NFC connections, or WIFI connections.

FIG. 2 shows a high-level overview of the system for sharing access to an electronic lock according to another embodiment. In such an embodiment, when the grantee performs a privileged action such as unlocking the associated electronic lock, the instant application 300 may execute the privileged action such as the unlock action through a server, and optionally through a single or plurality of networked devices, for example, a bridge 600. In one embodiment, the bridge 600 is a wireless communication bridge coupled to a first wireless communication device that communicates with the network via a device, including but not limited to a router, a 3G device, a 4G device, and the like, as well as mobile device. The bridge 600 is also coupled to a second wireless communication device that is coupled to the wireless communication elements of an electronic lock and and provides for more local communication. In other words, the first wireless communication device is in communication with the second wireless communication device via the bridge 600. The bridge 600 enables wireless communication between the associated electronic lock 500 and the instant application 300 on the mobile device 310 via the access management system 100. The communication can be based on one or more wireless connections, such as Bluetooth and/or Bluetooth LE connections, NFC connections, or WIFI connections. The bridge 600 may be arranged in wireless communication with a gateway or hub device (not shown), i.e. the first wireless communication device, according to various embodiments. The bridge 600 receives the access credential from the instant application 300 through the access management system 100 to perform the unlock action of the associated electronic lock 500. In other embodiments, each bridge 600 may be coupled to a cluster of electronic locks, and is typically beneficial that the overall system operates effectively. In some embodiments, the electronic locks include sensors or transceivers that are capable of connecting to the network 200 via low power wireless transmission standards such as ZWave, Zigbee or Bluetooth low energy.

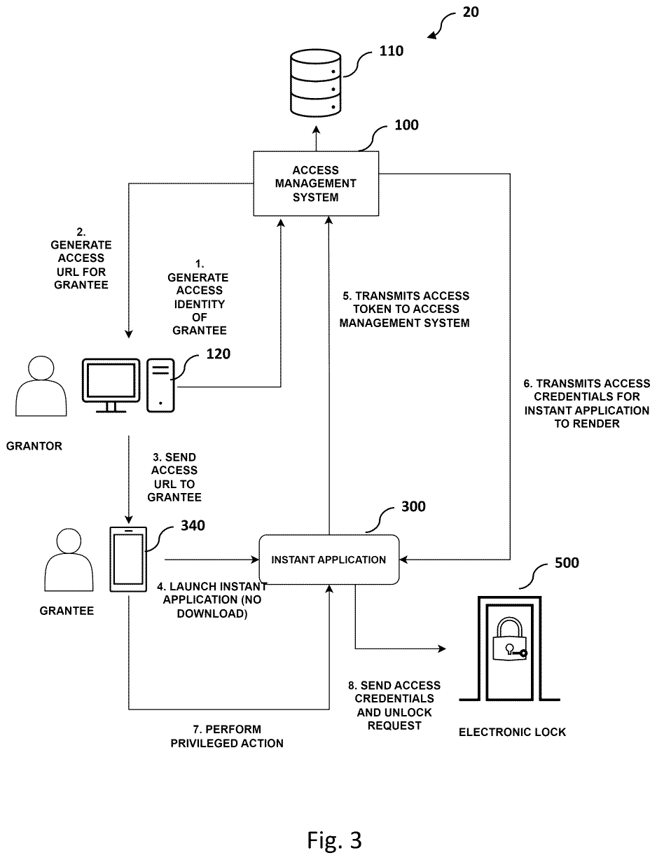

FIG. 3 illustrates a flow diagram of a method for sharing access to the electronic lock according to various embodiments. At step 1, the grantor will generate an access identity associated with the grantee. The access identity comprises one or more user identifiers of the grantee and an access right to be granted to the grantee. The user identifier of the grantee can include, but not limited to, a mobile device identifier such as a mobile number, name of the grantee, address of the grantee, etc.

In some embodiments, the access management system 100 provides an efficient way for a grantor or an administrator to manage the access identity and access rights of grantees. In one embodiment, the access management system 100 includes a user management module which assigns an access right to an authorized user or grantee to an associated electronic lock. Each electronic lock for an entry point may be identified by a lock identifier which may, for example, be associated with a lock serial number. Initially, the grantor defines the list of access rights grantees are provisioned by associating the access rights to specific roles assigned to grantee. For example, specific roles may be defined to include authorized users, staff, short-term guests, or long-term tenants of the residential or commercial units. In a non-limiting example, the access rights granted to the grantee include roles and permission level associated with the role. For example, if the role assigned to the grantee is of a short-term guest, the permission level granted to the premise associated with the electronic lock is limited by duration of time. In another example, if the role assigned to the grantee is of a housekeeper, the permission level granted to the premise associated with the electronic lock is limited within predetermined time periods within the day, for example, between 10 am-12 noon and between 3-6 pm. A skilled person would understand that the role and permission level can be configured as desired by various parameters. In another embodiment of the invention, when a grantor creates the access rights, further information about the access rights may be provided, including information but not limited to, text description, text headers, images, color scheme and user interface elements associated with that access right.

At step 2, the access management system 100 generates the access URL and this is sent to the computing device 120 of the grantor. At step 3, the grantor decides at an appropriate time to send the access URL through the computing device 120 to the mobile device 340 of the grantee through the network 200. As mentioned above, the grantor can send the access URL to the grantee's mobile device 340 via one or more means, such as by text messaging, email, or other distribution methods. In other embodiments, the access URL is in the form of a short uniform resource locator hyperlink embedded in the message, a matrix barcode for example barcode or a QR code, or encoded into an image for easy distribution. The access URL contains, but not limited to, an access token that is associated with the access identity of the grantee and/or access rights the grantor has granted to the grantee. Typically, the access URL is protected from unauthorized access via a cryptographic access token, rate limiting and other techniques commonly used in the art.

At step 4, when the grantee receives the the access URL on the mobile device 340, the grantee can activate the access URL and send an access request to the access management system at step 5. The access request includes the access token and access identity of the grantee. At step 6, on authentication of the access token and the access identity by the access management system, an access credential is sent to the mobile device 340 and the instant application is rendered on the mobile device 340 as a graphical user interface (GUI) feature based on the access token associated with the access rights provided to the grantee. The access URL enables the grantee to retrieve the instant application from the access management system, and information about the access rights and its associated information including the text information, images and user interface elements based on the data taken from the access token. The information is then used to render the user interface of the instant application.

At step 7, when the grantee performs a privileged action such as unlock the associated electronic lock on the mobile device 340, the instant application 300 in turn sends the access credentials to the electronic lock 500 to perform the unlock action in step 8. Communications between the instant application 300 on the mobile device and the electronic lock 500 can be based on one or more wireless connections, such as Bluetooth and/or Bluetooth LE connections, NFC connections, or WIFI connections.

In some embodiments, the grantor may be a third party system integrator or a service provider integrating the electronic locking systems into their workflow, for example, a property management system that receives hotel room reservation bookings from guests, and wishes to grant access to a guest to the room. The system integrator may create access, together with the access details and user interface elements via an application programming interface to an access management system. The access management system may generate the access URL, after which the system integrator may send the access URL to the guest directly. The guest after accessing the access URL will execute the instant application on the user device. The instant application will render the access details for example, the hotel's logo and color scheme, the room reservation details to the guest. The guest may launch the instant application at any time he wishes to access the room via the access URL according to the access right granted. The instant application may retrieve the access credential to present to the electronic lock on the room door to perform the privileged action, or execute the privileged action through a server, and optionally through a single or plurality of networked devices, such as a bridge.

According to various embodiments, the database 110 may store the access unique resource locators (URLs), the access identity of the grantees, the access tokens issued by the access management system 100 and the access credential issued to grantees for the purpose of unlocking the associated electronic lock. In another embodiment, the server implementing the access management system 100 may store the access unique resource locators (URLs), the access identity of the grantees, the access tokens issued by the access management system 100 and the access credential issued to grantees in multiple storage locations in the database 110. The particular storage location may be associated with the access URL such that the access URL may be used to access the data containing the instant application stored in the particular storage location in the database 110.

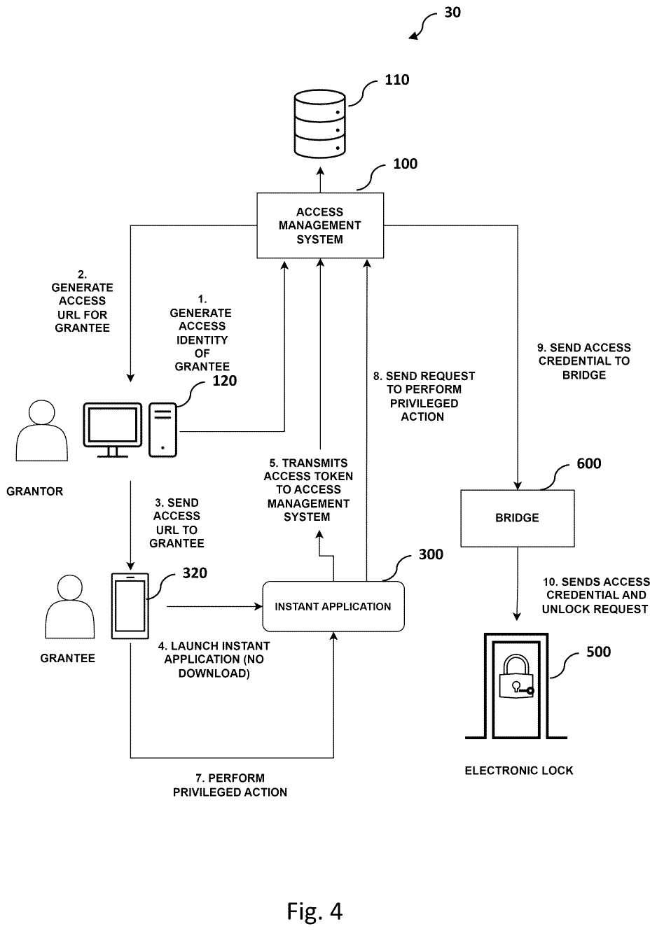

FIG. 4 shows a flow diagram of a method of sharing access to an electronic lock according to another embodiment. Steps 1 to 6 of FIG. 3 and FIG. 4 are identical. The difference between FIG. 3 and FIG. 4 is at steps 8-10, i.e. the instant application executes the privileged action, for example, the unlock request for unlocking the electronic lock, through the access management system 100 and a bridge 600. Instead of the instant application 300 communicating directly with the electronic lock 400 in FIG. 3, the instant application 300 sends a request to the access management system 100 to perform the privileged action. The access management system 100 subsequently transmits the access credential to the bridge 500 which is then sent directly to the specific electronic lock 400 to perform the privileged action at step 10.

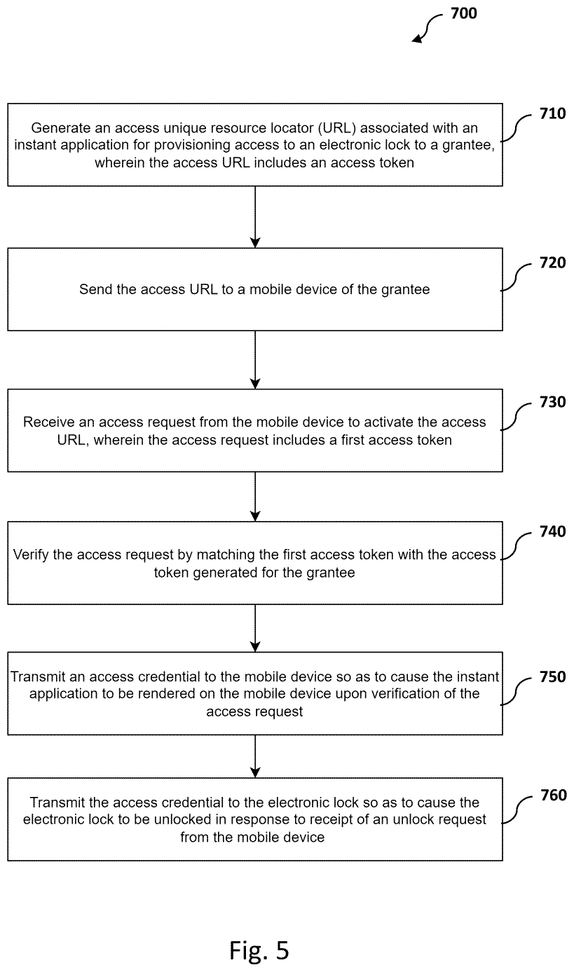

FIG. 5 illustrates a flow diagram of a method of sharing access to an electronic lock according to another embodiment. At step 710, the access management system 100 generates an access URL associated with an instant application for provisioning access to the electronic to a grantee. In some embodiments, the access URL includes an access token. The access token is associated with an access identity of the grantee. In some embodiments, the grantor will first generate an access identity associated with the grantee. The access identity comprises one or more user identifiers of the grantee. The user identifier of the grantee can include, but not limited to, a mobile device identifier such as a mobile number, name of the grantee, address of the grantee, etc. In another embodiment, the access token is associated with a lock identifier of the electronic lock that the grantee has been given access to. In another embodiment, the access token is associated with an access right to be granted to the grantee. In a non-limiting example, the access right includes an assigned role and permission level assigned to grantee. For example, the assigned role may be defined to include an authorized user, a staff, a short-term guest, or a long-term tenant of the residential or commercial unit. For example, if the assigned role is a short-term guest, the permission level granted to the premise associated with the electronic lock is limited by duration of time. In another example, if the assigned role assigned is a housekeeper, the permission level granted to the premise associated with the electronic lock is limited within predetermined time periods within the day, for example, between 10 am-12 noon and between 3 -6 pm. A skilled person would understand that the assigned roles and permission levels can be configured as desired by various parameters. In another embodiment of the invention, when a grantor creates the access right, further information about the access right may be provided, including information but not limited to, text description, text headers, images, color scheme and user interface elements associated with that access right.

At step 720, the access management system 100 sends the access URL at an appropriate time to the mobile device 340 of the grantee through the network 200. As mentioned above, the grantor can send the access URL to the grantee's mobile device 340 via one or more means, such as by text messaging, email, or other distribution methods. In one embodiment, the access URL is in the form of a short uniform resource locator hyperlink embedded in the message, a matrix barcode for example barcode or a QR code, or encoded into an image for easy distribution. The access URL contains, but not limited to, an access token that is associated with the access identity of the grantee and/or access rights the grantor has granted to the grantee. Typically, the access URL is protected from unauthorized access via a cryptographic access token, rate limiting and other techniques commonly used in the art.

At step 730, the access management system 100 receives an access request from the mobile device to activate the access URL. When the grantee receives the access URL on the mobile device 340, the grantee can activate the access URL and send an access request to the access management system. The access request includes the access token and access identity of the grantee.

At step 740, the access management system 100 verifies the access request by matching the access token received from the mobile device with the access token that is generated for the grantee by the access management system on creation of the access URL at step 710.

At step 750, on a positive verification of the access request, the access management system transmits an access credential to the mobile device 340 and the instant application is rendered on the mobile device 340 as a graphical user interface (GUI) feature based on the access token associated with the access rights provided to the grantee. The access URL enables the grantee to retrieve the instant application from the access management system, and information about the access rights and its associated information including the text information, images and user interface elements based on the data taken from the access token. The information is then used to render the user interface of the instant application. On a negative verification of the access request, i.e. where the access token associated with the access request that is transmitted to the access management system does not match the access token generated on creation of the access URL at step 710, the access management system 100 will deny transmission of the access credential to the mobile device, and the instant application will not be rendered on the mobile device. An error message will appear on the mobile device to check with the grantor for log in access.

At step 760, when the grantee performs a privileged action such as an unlock request to unlock the electronic lock on the instant application 300, the instant application 300 in turn sends the access credential to the electronic lock 500 to perform the unlock action in step 8. Communication of the access credential between the instant application 300 on the mobile device and the electronic lock 500 can be based on one or more wireless connections, such as Bluetooth and/or Bluetooth LE connections, NFC connections, or WIFI connections.

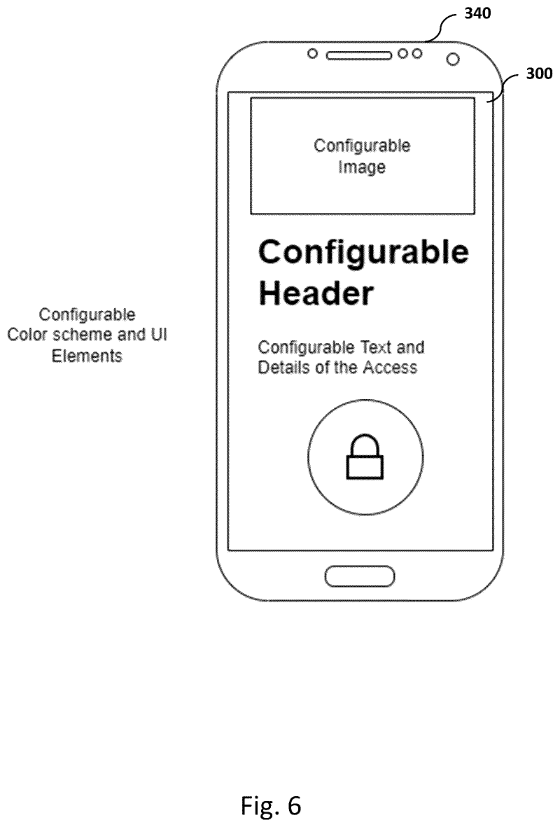

FIG. 6 illustrates an instant application rendered on a mobile device according to various embodiments. The instant application 300 is activated and rendered on the mobile device 340 as a graphical user interface (GUI) feature based on the access identity configured for the grantee and identity of the grantor. The instant application 300 is configurable based on the access identity of the grantee and the identity of the grantor. When the grantor generates the access URL associated with the instant application, further information about the instant application 300 may be provided, including information, such as but not limited to, text description, text headers, images, color scheme and user interface elements associated with that access. In other words, the instant application 300 includes configurable elements that are configured based on the access identity of the grantee and identity of the grantor. The configurable elements include a configurable header for textual information, a configurable image for placing a brand or logo of the grantor, a configurable access entry data and a privileged action button for performing lock and unlock actions. The configurable access entry data is information related to the room number. Each of the configurable elements can be configured and generated by the administrator or grantor. The instant application retrieves data from the access management system, information about the access and its associated information including the text information, images and user interface elements based on the data taken from the access token. The information is then used to render the user interface of the instant application.

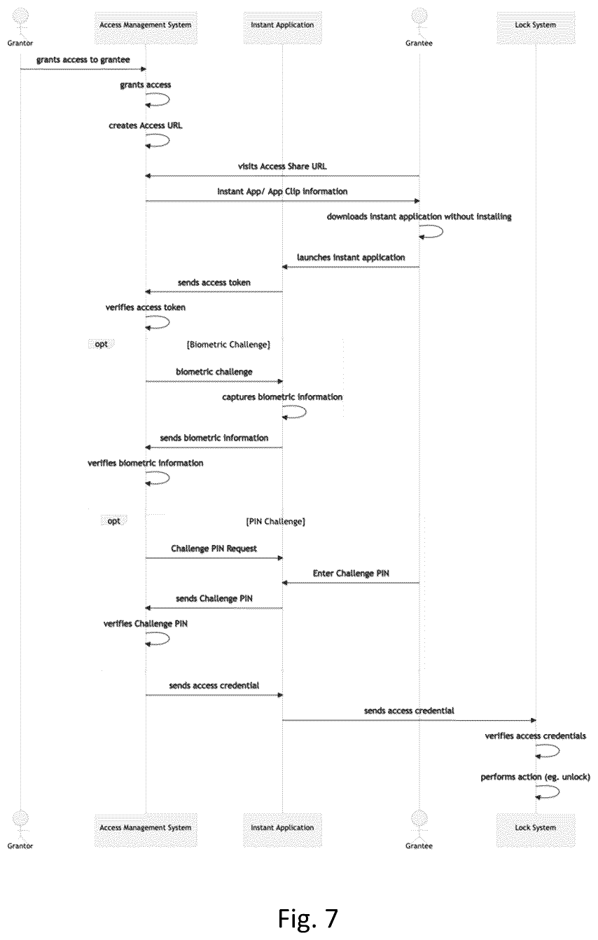

FIG. 7 shows a detailed flow diagram of a grantor sharing access to the electronic lock with a grantee according to various embodiments. The flow diagram is similar to that of FIG. 3, with the exception of including a single factor or a multi-factor authentication method for performing a privileged action. In various embodiments, the step of providing one or more authentication requests can be implemented upon verification of the access request in which the access token from the mobile device is verified. In various embodiments, the electronic lock 400, 500 may rely on a single factor or multi-factor authentication methods for unlocking the electronic lock 400, 500. Where increased security is desired, multi-factor authentication is used. A multi-factor authentication is based on two or more authentication factors, and these factors are based on what the user (or grantee) knows and who the user (or grantee) is. For example, authentication factors that are based on what the user knows may include a pre-configured password or PIN issued by the owner or administrator, or a server-generated password or a one-time password. Authentication factors that are based on who the user is include biometric information which may include facial recognition, fingerprint information, retinal information or voice recognition. In such a situation, if the universal shareable access URL is leaked, a person having the access URL but does not pass the multi-factor authentication will not be able to gain access to perform privileged action on the electronic lock.

When the grantor (or service provider) decides to share the access of the electronic lock with the grantee, the grantor can configure the option of providing the grantee with the type of authentication challenge/request. The authentication challenge/request includes a biometric challenge or a password challenge, or both. In an embodiment of the invention, after step 5 of FIG. 3 and FIG. 4 is initiated, i.e. upon verification of the access token received by the access management system, and before the instant application is rendered on the grantee mobile device, the access management system 100 may request one or more multi-factor authentication challenges.

In various embodiments, and in response to a positive verification of the access request where the access token is verified by the access management system, the access management system may generate a first factor authentication request to be transmitted to the mobile device. In response to the first factor authentication request, the grantee will respond with an input first factor authentication data on the mobile device. The access management system receives the input first factor authentication data and determines if the input first factor authentication data corresponds with the first factor authentication data associated with the grantee.

If the first factor authentication request relates to a biometric challenge, the grantee's biometric features must be pre-registered with the access management system 100 and stored in the database 110 for verification. For example, a guest of a hotel will be received by the receptionist who will proceed to check the guest in. Biometric features of the guest can be obtained during the check in process with the guest's consent for the purpose of performing the privileged actions for locking and unlocking the electronic lock to their room. After the instant application is launched via the activation of the access URL based on the access token, the instant application receives a first factor authentication request, i.e., a biometric authentication challenge from the access management system 100. The instant application 300 will proceed to capture the input first factor authentication data received from the mobile device, i.e. biometric information, for example, face recognition, and may include other ways of performing anti spoofing detection for example liveness detection, known in the art. When the access management system validates that the grantee is indeed the person allowed access, the access credential is then sent to instant application to perform the privileged action. In various embodiments, the first factor authentication request may include use of a unique passcode or a biometric signature. A biometric signature is a unique physical characteristic of a user and can include facial profile information, fingerprint information, voice recognition or retinal information of a user.

In another embodiment, if the second factor authentication request relates to a challenge Personal Identification Number (PIN), the challenge PIN may be distributed to the grantee via the access management system, or via other means of distribution for example email, text messaging or other forms of dissemination. The PIN is a numeric or alphanumeric passcode used in the process of authenticating a user accessing a system. When the grantee mobile device receives a PIN challenge from the access management system, the mobile device will present a user interface for the grantee requesting access to input the challenge PIN. When the access management system validates the challenge PIN, the access credential is then sent to the mobile device for performing the privileged action.

The access management system 100 comprises an access code generator (not shown) that is responsible for generating first factor or second factor authentication data if the said factor authentication data is a challenge PIN or unique passcode. The first or second factor authentication codes may include one-time passcodes, time-based one-time passcodes, cryptographic keys, electronic keys or the like. If the second factor authentication data is a challenge PIN, upon authenticating a first factor authentication data received from a mobile device, the access code generator generates a second factor authentication code and stores them in the database 110 together with the relevant data about the associated user devices, electronic locks, locations, access identity of grantees, etc. The access code generator also handles other administrative tasks such as automatic expiration of second factor authentication codes, initiation of second factor authentication codes for transmission to associated user devices or associated electronic locks. The transmission of second factor authentication codes to associated mobile devices can be executed by implementing one or more layers of a layered communications protocol used for the transmission. Although the access code generator is shown as part of the access management system 100, the access code generator may be on a separate application server 160 or server. In various embodiments, a skilled person would envisage that the first factor authentication request and the second factor authentication request can be, but not limited to, a challenge PIN request, a biometric signature or a unique passcode.

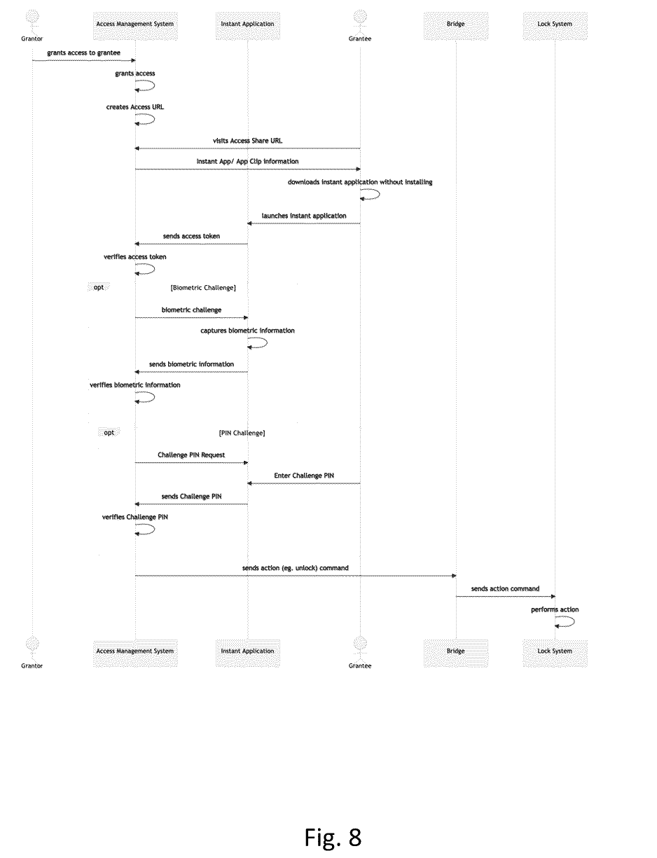

FIG. 8 shows a flow diagram of a grantor sharing access to the electronic lock with a grantee according to another embodiment. The flow diagram is similar to that of FIG. 6, with the exception that after the multi factor authentication is performed and passed, the grantee may perform the privileged action using the instant application, through the server, or optionally through a single or plurality of networked devices, for example a bridge.

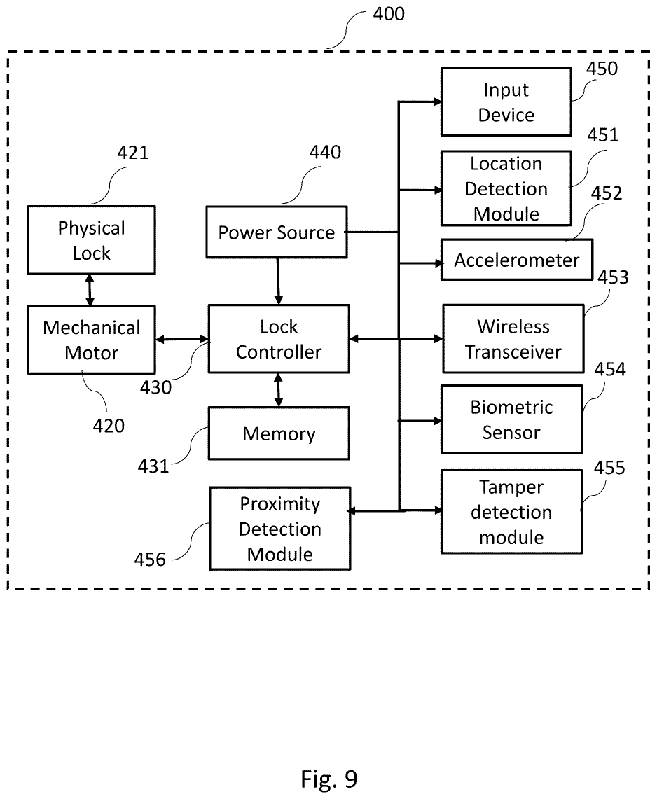

FIG. 9 illustrates a high-level block diagram showing the internal components of the electronic lock 400 configured for wireless communication with the access management system 100, user device, and server according to various embodiments. The electronic lock 400 is installed on an entry point of an object, property or key installation. The entry point may include a door, such as a door of a building, a door in a residential or commercial unit, a door of a cabinet, a door of a safe, a door of a vehicle, door of a container, door of a key installation, etc. The electronic lock 400 comprises a lock controller 430 in data communication with a memory 430 and a wireless transceiver 453, a power source 440 and a mechanical motor 420 coupled to a physical lock 421. In some embodiments, the electronic lock 400 includes an input device 450 such as touch screen or virtual keypad for entering an input. In some embodiments, the electronic lock 400 includes a biometric sensor 454 for capturing biometric data such as a fingerprint sensor for capturing fingerprint information or an image capturing sensor for capturing facial profile information of users.

The electronic lock 400 includes a wireless transceiver 454 for wireless communication with an access management system 100 or an application server through a network 200. In some embodiments, the wireless transceiver 454 can communicate wirelessly with a user device or through the access management system 100 via the network 200. In various embodiments, the wireless transceiver 454 can communicate via any of various technologies already mentioned above, such as a cellular network, a short-range wireless network, a wireless local area network (WLAN), a low-power Wide Area Network (LP-WAN), etc. The cellular network can be any of various types, such as code division multiple access (CDMA), time division multiple access (TDMA), global system for mobile communication (GSM), long term evolution (LTE), 3G, 4G, 5G, etc. The short-range wireless network can also be any of various types, such as Bluetooth, Bluetooth Low Energy (BLE), near field communication (NFC) etc.

The electronic lock 400 includes a lock controller 430. For example, the lock controller 430 maintains an activity log of all entries and exit of users and transfers the information to the application server via wireless communication facilitated by the wireless transceiver 453 for storage in the lock user database. Whenever a user accesses an entry point via the electronic lock 400, the lock controller 430 logs the unlocking and locking of the electronic locks as events. These events are saved on the memory 431 of the electronic lock 400 and are sent via the network 200 to the access management system 100 and can be accessible by the access right owner or administrator. In some embodiments, unsuccessful attempts at entry or an unauthorized entry can be logged and transmitted to the access right owner or administrators for them to be notified via their user devices immediately.

In some embodiments, the electronic lock 400 includes a tamper detection module 455. The tamper detection module 455 includes sensors that detect when a physical lock is manually opened or closed by tracking the output signals of the mechanical motor as the bolt of the physical lock is manually actuated. In some embodiments, the sensors include a capacitive or optical sensor that can track the opening or closing of the physical lock. In some embodiments, the sensors include a magnetic field sensor on the mechanical motor that can track the opening or closing of the physical lock. In some embodiments, the sensors can detect when the input device such as a keypad front panel is forcibly removed. In some embodiments, the sensors include an accelerometer or motion sensors that detect abnormal shocks to the electronic lock. For example, the accelerometer or motion sensor can detect an acceleration that is more than a predetermined amount or above a maximum rate of acceleration observed during a period. This can indicate that a person may be trying to attempt a break in or forced entry of the door. In the aforesaid instances of unauthorized entry or tamper events, the lock controller 230 sends a tamper alarm event to the access management system and the administrator and access right owner can be notified through their user devices. If the sensor senses that the lock is open, the lock controller 230 sends a ‘door not closed’ alarm event to the access management system and the administrator and access right owner can be notified through their user devices.

In some embodiments, the electronic lock 400 includes a location detection module 451. The electronic lock 400 comprises a global positioning system (GPS) sensor that allows it to detect its location. The electronic lock 210 is designated a particular geolocation during the setup process and this is registered in the access management system and application server. In the event the electronic lock is removed from its designated location, the GPS sensor detects a different geolocation that falls out of range of its designated location, and the lock controller sends an ‘out of location’ alarm event to the access management system and application server. In other embodiments, the electronic lock 400 may be securing high-value cargo or equipment that is intended to be transported to an intended destination via commercial vehicles. In order to provide increased security and to ensure that the high-value cargo or equipment can only be accessed when it reaches its intended destination, the electronic lock can be configured to receive first factor authentication data or second factor authentication data only when its GPS sensor detects that it is within a virtual perimeter of the intended destination. This is known as geofencing, and the lock management module allows the administrator to configure the electronic lock to activate access to the electronic lock only when the GPS sensor detects that it has entered a predetermined virtual boundary around a geographical location.

The electronic lock 400 includes the standard structure of conventional door locks with moving parts to lock or to unlock the physical lock. The lock controller 430 controls a mechanical motor 420 which causes the mechanical motor 420 to open or close the physical lock 421. The mechanical motor 420 can have associated gears in order to generate the torque required to move the physical lock 421. The physical lock 421 may take many form factors including padlocks, deadbolts, mortises, rim locks, latches and electro-magnetic door locks.

The lock controller 430 includes a memory 431 capable of storing first factor authentication data and associated roles and permission levels of access right owners and access right grantees, biometric data, access details, logs of user interactions or associated timestamps and a record of the access right owner or administrator data. The memory 431 may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magneto resistive Random Access Memory) or a PCRAM (Phase Change Random Access Memory).

As used herein, the term ‘controller’ broadly refers to and is not limited to single or multi-core general purpose processor, a special purpose processor, a conventional processor, a graphical processing unit, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit, a system on a chip (SOC), and/or a state machine.

The electronic lock 400 includes a power source 440 that provides power supply to the electronic lock 400. The power source can be a battery energy source, for example, a rechargeable battery.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embrace.

1. A computer-implemented method for sharing access to an electronic lock comprising:
generating, by the access management system, an access unique resource locator (URL) associated with an instant application for provisioning access to the electronic lock to a grantee, wherein the access URL includes an access token;
sending the access URL to a mobile device of the grantee
receiving, by the access management system, an access request from the mobile device to activate the access URL, wherein the access request includes a first access token,
verifying the access request by matching the first access token with the access token generated for the access URL;
transmitting an access credential to the mobile device to cause the instant application to be rendered on the mobile device upon a positive verification of the access request, and
transmitting the access credential to the electronic lock so as to cause the electronic lock to be unlocked in response to receipt of an unlock request on the instant application.

2. The computer-implemented method according to claim 1, wherein the access URL includes a shortened uniform resource locator hyperlink.

3. The computer-implemented method according to claim 1, wherein the access URL includes a matrix barcode.

4. The computer-implemented method according to claim 1, wherein the access token is associated with an access identity of the grantee.

5. The computer-implemented method according to claim 4, wherein the access identity includes one or more user identifiers associated with the grantee.

6. The computer-implemented method according to claim 1 or claim 4, wherein the access token is associated with an access right granted to the grantee.

7. The computer-implemented method according to claim 1, wherein the access credential is transmitted to a bridge before the access credential is transmitted to the electronic lock.

8. The computer-implemented method according to claim 1, wherein the instant application includes one or more configurable elements configured based on an identity of the grantee and an identity of the grantor.

9. The computer-implemented method according to claim 1, further including the steps of;
in response to the positive verification of the access request, generating, by the access management system, a first factor authentication request to be transmitted to the mobile device;
receiving, by the access management system, an input first factor authentication data from the mobile device;
determining, if the input first factor authentication data corresponds with the first factor authentication data associated with the grantee.

10. The computer-implemented method according to claim 9, further including the steps of;
generating, by the access management system, a second factor authentication request for transmission to the mobile device in response to the input first factor authentication data matching the first factor authentication data associated with the grantee;
receiving, by the access management system, an input second factor authentication data from the mobile device; and
determining if the input second factor authentication data corresponds with the second factor authentication data associated with the grantee.

11. A system for sharing access to an electronic lock, the system comprising:
at least one processor; and
at least one memory including computer program code;
the at least one memory and the computer program code configured to, with the at least one processor, cause the system at least to:
generate, by the access management system, an access unique resource locator (URL) associated with an instant application for provisioning access to the electronic lock to a grantee, wherein the access URL includes an access token;
send the access URL to a mobile device of the grantee;
receive, by the access management system, an access request from the mobile device to activate the access URL, wherein the access request includes a first access token;
verify the access request by matching the first access token with the access token generated for the access URL;
transmit an access credential to the mobile device to cause the instant application to be rendered on the mobile device upon a positive verification of the access request, and
transmit the access credential to the electronic lock so as to cause the electronic lock to be unlocked in response to receipt of an unlock request on the instant application.

12. The system according to claim 11, wherein the access URL includes a shortened uniform resource locator hyperlink.

13. The system according to claim 11, wherein the access URL includes a matrix barcode.

14. The system according to claim 11, wherein the access token is associated with an access identity of the grantee.

15. The system according to claim 11, wherein the access identity includes one or more user identifiers associated with the grantee.

16. The system according to claim 11 or claim 14, wherein the access token is associated with an access right granted to the grantee.

17. The system according to claim 11, wherein the access credential is transmitted to a bridge before the access credential is transmitted to the electronic lock.

18. The system according to claim 11, wherein the instant application includes one or more configurable elements configured based on an identity of the grantee and an identity of the grantor.

19. The system according to claim 11, further including the steps of;
in response to the positive verification of the access request, generate, by the access management system, a first factor authentication request to be transmitted to the mobile device;
receive, by the access management system, an input first factor authentication data from the mobile device;
determine, if the input first factor authentication data corresponds with the first factor authentication data associated with the grantee.

20. The system according to claim 19, further including the steps of;
generate, by the access management system, a second factor authentication request for transmission to the mobile device in response to the input first factor authentication data matching the first factor authentication data associated with the grantee;
receive, by the access management system, an input second factor authentication data from the mobile device; and
determine if the input second factor authentication data corresponds with the second factor authentication data associated with the grantee.

21. A computer program comprising instructions which, when the program is executed by a computer, cause the computer to carry out the method of any one of claims 1-10.

22. A computer-readable medium comprising instructions which, when executed by a computer, cause the computer to carry out the method of any one of claims 1-10.
